(19) United States
(12) Patent Application Publication
(10) Pub. No.: US 2008/0258743 A1
(43) Pub. Date: Oct. 23, 2008

(54) CONDENSATION SENSOR

(76) Inventors: Hans-Michael Schmitt, Muennerstadt (DE); Thomas Polzer, Bad Neustadt (DE); Andrej Afanasjevas, Bad Neustadt (DE)

Correspondence Address: Muncy, Geissler, Olds & Lowe, PLLC, P.O. BOX 1364, FAIRFAX, VA, 22038-1364, US

(21) Appl. No.: 12/018,183

(22) Filed: Jan. 22, 2008

Related U.S. Application Data
(63) Continuation of application No. PCT/EP2006/007221, filed on Jul. 21, 2006.

(30) Foreign Application Priority Data
Jul. 21, 2005 (DE) DE 102005033987

(51) Int. Cl. G01N 19/10

(52) U.S. Cl. 324/694; 73/335.05

(57) ABSTRACT

A sensor arrangement is provided for attachment to an inside of a windshield in a motor vehicle, including at least a sensor element that determines the relative humidity and a printed circuit board that electrically contacts the sensor element, wherein the sensor element is attached to the printed circuit board in the direction of the windshield, and a compensating film that accommodates the curvature of the window is present at least between the sensor element and the windshield, and the compensating film is an adhesive film.

This nonprovisional application is a continuation of International Application No. PCT/EP2006/007221, which was filed on Jul. 21, 2006, and which claims priority to German Patent Application No. De 102005033987, which was filed in Germany on Jul. 21, 2005, and which are both herein incorporated by reference.

### BACKGROUND OF THE INVENTION

1. Field of the Invention

The present invention relates to a sensor arrangement for attachment to an inside of a windshield in a motor vehicle, including at least a sensor element that determines the relative air humidity and a printed circuit board that electrically contacts the sensor element, wherein the sensor element is attached to the printed circuit board in the direction of the windshield.

2. Description of the Background Art

Comfortable air conditioning systems in motor vehicles provide, in addition to regulation of the passenger compartment temperature, the possibility of detecting fogging of the windows, in particular of the windshield, and initiating suitable countermeasures. In this connection, condensation is formed on the windows because of the difference in temperature at the surface of the window and in the passenger compartment. This frequently occurs when the temperature difference between the motor vehicle passenger compartment and the ambient temperature is very large. With respect to the relative air humidity in the passenger compartment, when these large temperature differences prevail, the temperature at the inner surface of the windows drops below the dew point temperature, so that fogging of the windows occurs. A variety of systems have become known for sensing incipient fogging on the window of a motor vehicle.

DE 101 52 999 A1 describes a sensor unit for detecting a tendency toward condensation on a window, which is a motor vehicle window in particular. The moisture-sensitive sensor here is composed of a moisture sensor that operates on the capacitive principle including two electrodes, between which is located a moisture-sensitive polymer element. Here, the direct thermal coupling of the sensor to the window preferably is accomplished through the electrodes. Alternatively, a metal plate can be used that is thermally connected to one of the electrodes. In this context, the metal plate is adhered to the windows by means of a thin film with thermal conductivity.

Another sensor arrangement for sensing the condensation on a motor vehicle windshield is described in DE 101 04 942 A1. In one embodiment, the moisture-sensitive sensor element is mounted on a circuit board, and the sensor element is adhered directly to the inside of a window by means of a thermally conductive layer. What is important here is the use of thermally conductive films, so that good thermal coupling of the sensor element to the window takes place. A disadvantage of this arrangement is the use of the costly thermally conductive adhesive layer, for example.

### SUMMARY OF THE INVENTION

It is therefore an object of the present invention to provide an economical, compact condensation sensor or sensor arrangement. Moreover, the sensor arrangement should be designed with a simple structure and be easy to tie in to existing applications.

The object of the invention is attained by the means that a compensating film that accommodates the curvature of the window is present at least between the sensor element and the windshield, and the compensating film is an adhesive film. The inventive construction makes it possible to ensure good connection to the windshield, and the simple construction makes it possible to provide an economical sensor arrangement. Due to the direct attachment of the sensor element to the windshield, moreover, good thermal coupling of the sensor element to the window temperature is ensured. As a result of the direct connections of the sensor element to the windshield, the film with good thermal conductivity can be omitted here. Due to the inventive use of a spacer film, it is possible, furthermore, to attach and/or to connect the sensor element to the printed circuit board so that optimal connection is ensured along with minimal influencing of the temperature by the electronic components on the printed circuit board or in the sensor arrangement. In this context, the spacer film has an opening that is larger than the sensor element so that circulation of the air from the passenger compartment is ensured in the vicinity of the sensor element. To this end, in addition to the electrical or mechanical connectors, the printed circuit board contains a recess whose dimensions correspond to the dimensions of the opening in the spacer film, for example.

In another embodiment of the invention, the spacer film is angled in design, wherein the spacer film is angled away from the windshield. This provides the advantage that additional electronic components of the sensor arrangement can be mounted on the spacer film, making it possible to reduce the dimensions of the sensor arrangement. This provides the advantage that the field of view in the windshield is only minimally compromised.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a sensor arrangement in a three-dimensional, assembled view, and

FIG. 2 is an exploded view of a sensor arrangement constructed according to the invention.

### DETAILED DESCRIPTION

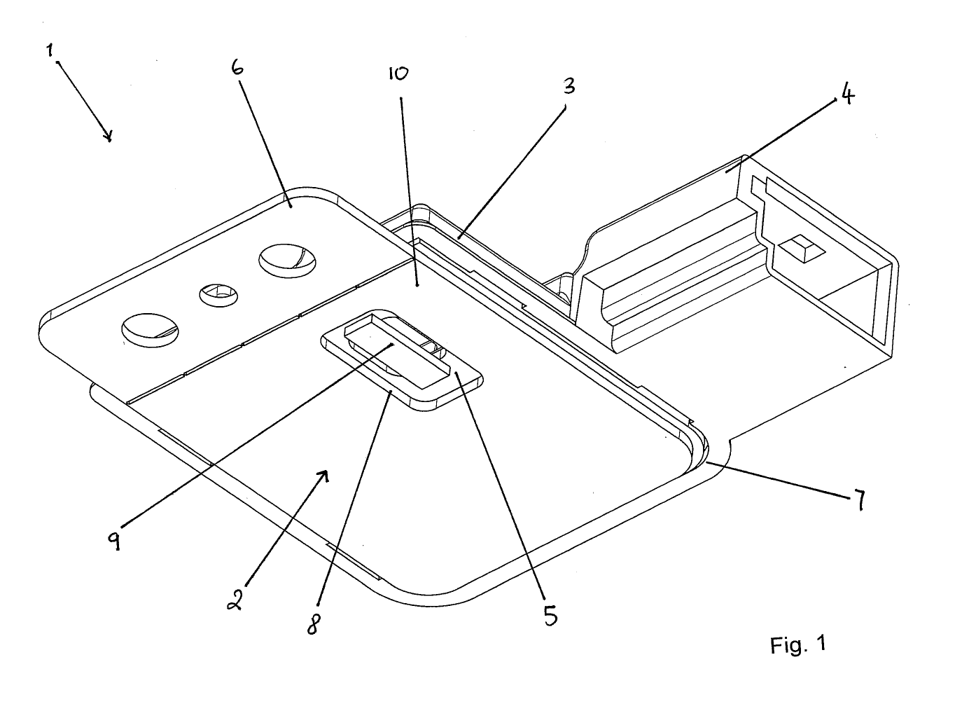

In FIG. 1, an inventive sensor arrangement 1 is shown in a three-dimensional view from its underside 2. The underside 2 here means the side of the sensor arrangement 1 that is affixed to the windshield. Molded on the housing 3 is a plug-in connection 4. Accommodated inside the housing 3 and flush therewith is the printed circuit board 5, wherein the printed circuit board 5 is held, firstly, by the solder joints to the plug contacts, and secondly by a molding compound that at least partially fills the housing 3. In this example embodiment, the spacer film 6 extends beyond the edge 7 of the housing 3, wherein the spacer film 6 rests flush against the printed circuit board 5 and the edge 7 of the housing 3. The spacer film 6 in this example embodiment has an essentially rectangular opening 8 in which the sensor element 9 is held by means of the printed circuit board 5. The adhesive film 10 is applied in this example embodiment to the spacer film 6, only covering parts of the spacer film 6. The adhesive film 10 firstly fastens the sensor arrangement 1 to the window (not shown) and secondly serves to compensate for the window curvature, so that the adhesive film 10 is more appropriately described as compensating film 10.

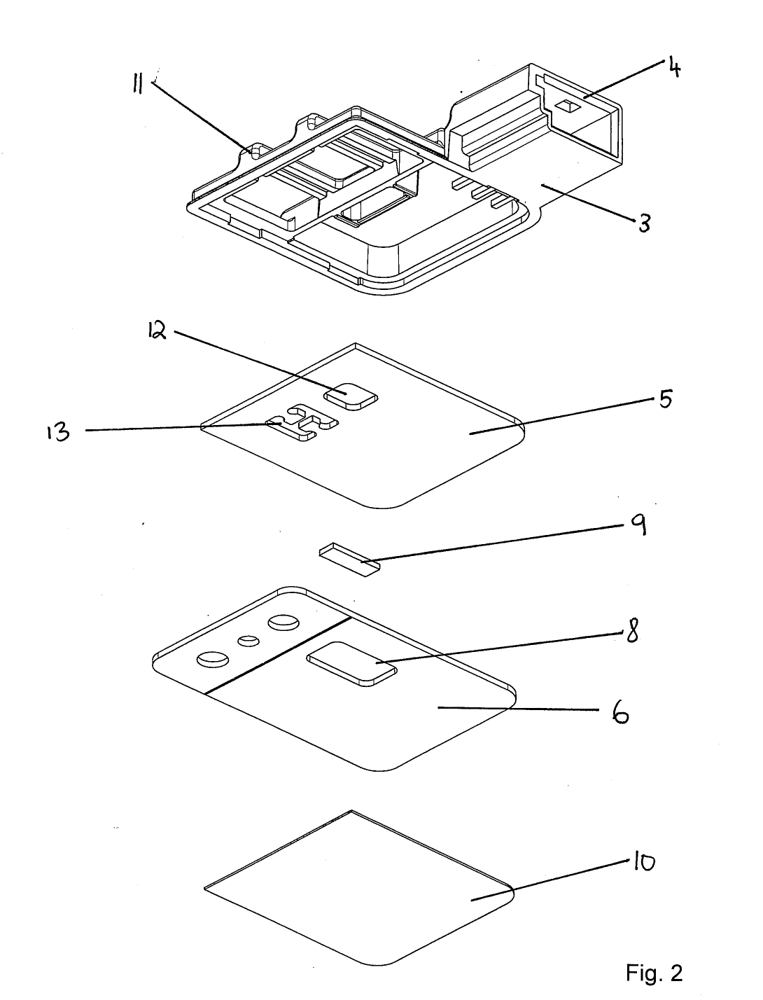

FIG. 2 provides a perspective view of the schematic structure of the important elements of the invention in an exploded view. Identical components have been labeled with identical reference numbers here.

The housing 3 has ribs 11, which on the one hand reinforce, support, stabilize and form the housing 3, and on the other hand the ribs 11 permit unhindered air circulation in the direction of the sensor element 9. In this exemplary embodiment, the sensor element 9 is electrically contacted and fastened to the printed circuit board 5 through the recess 12. Here, the sensor element 9 lies on the printed circuit board 5. In order to bridge the distance to the windshield, the spacer film 6 is inserted between the printed circuit board 5 and the compensating film 10. Here, the spacer film 6 can be glued to the printed circuit board 5, for example. In addition, it is also possible to attach the spacer film 6 to the housing 3 by a form-fitting or integral joint.

An additional recess 13, which also accommodates electronic components, is also placed in the printed circuit board 5. It is thus possible, for example, to position a temperature sensor in the area 13, in order to sense the temperature of the circulating air and also to analyze and/or compensate the heating by the electronic components and the effect thereof on the sensor element 9.

The thickness of the compensating film 10 is customarily between 0.5 mm and 1 mm, this thickness range being adequate to compensate for the window curvature with respect to the sensor arrangement 1 just described. The thickness of the spacer film 6, which can also be called the separator film 6, depends on the thickness of the moisture-sensitive sensor element 9, and lies in a range from 1 mm to 3 mm. The spacer film 6, or the plastic spacer element 6, is preferably made of polyimide. In a region 14, additional openings 15 are provided in the spacer film 6 in the form of holes, which serve to accommodate components or also for positioning on the windshield. The printed circuit board 5 is designed as a conventional circuit board, and carries the additional components required for functioning of the sensor arrangement 1 or for transmission to a bus system. Electrical contact to the printed circuit board 5 and the sensor element 9 is provided by means of the jack 4, by which means they are connected to the motor vehicle's on-board electronics and, here, to the air conditioning system regulation, in particular. Moreover, the electronic components on the printed circuit board 5, such as the sensor element 9, are described in DE 101 52 999, which is expressly referenced here.

The spacer film 6 may be implemented in an angled form, with the angling extending into the housing 3 of the sensor arrangement 1, for example. Doing so makes it possible to position electrical components on the spacer film 6, so that the printed circuit board may be made with smaller dimensions, thus simultaneously making it easier to integrate the sensor arrangement 1, for example in the base of a rearview mirror. In this connection, the spacer film 6 may be angled by 90 degrees, for example. This makes possible an angled construction of a sensor arrangement. As a result, the area of the windshield required for connecting the sensor arrangement 1 can be kept very small.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A sensor arrangement for attachment to an inside of a windshield in a motor vehicle, the sensor arrangement comprising:
at least one sensor element that determines a relative humidity; and
a printed circuit board electrically contacting the sensor element,
wherein the sensor element is attached to the printed circuit board in a direction of the windshield,
wherein a compensating film that accommodates the curvature of the window is provided at least between the sensor element and the windshield, and
wherein the compensating film is an adhesive film.

2. The sensor arrangement according to claim 1, wherein a spacer film is present between the printed circuit board and the compensating film, and the spacer film has an opening and the sensor element rests against the compensating film through the spacer film.

3. The sensor arrangement according to claim 2, wherein a thickness of the spacer film corresponds to a thickness of the sensor element, and the opening in the spacer film is larger than the sensor element.

4. The sensor arrangement according to claim 2, wherein the spacer film is designed to angle away from the windshield.

5. The sensor arrangement according to claim 2, wherein at least one electrical component belonging to the sensor arrangement is attached to the angled region of the spacer film.

6. The sensor arrangement according to claim 2, wherein the spacer film is made of plastic, in particular polyimide.

7. The sensor arrangement according to claim 2, wherein the printed circuit board is attached flush within a housing, and the spacer film abuts in the area of the printed circuit board or in the area of the printed circuit board and the housing or abuts in the area of the printed circuit board and the housing and extends beyond the housing.
